(19) United States
(12) Patent Application Publication
(10) Pub. No.: US 2026/0067570 A1
(43) Pub. Date: Mar. 5, 2026

(54) CONTROL APPARATUS, IMAGE PICKUP APPARATUS, LENS APPARATUS, CONTROL METHOD, AND STORAGE MEDIUM

(71) Applicant: CANON KABUSHIKI KAISHA, Tokyo (JP)

(72) Inventor: GO NAITO, Kanagawa (JP)

(21) Appl. No.: 19/266,444

(22) Filed: Jul. 11, 2025

(30) Foreign Application Priority Data
Sep. 4, 2024 (JP) 2024-151856

(51) Int. Cl. H04N 23/68; H04N 23/667

(52) U.S. Cl. CPC H04N 23/683; H04N 23/667

(57) ABSTRACT

A control apparatus calculates a correction amount for image stabilization using a signal obtained from a shake detector, and controls an image stabilizing unit configured to perform the image stabilization based on the correction amount and a control characteristic. In a case where a state is transitioned to a first state, a second state, and a third state in this order according to a user instruction, the control apparatus switches a first calculation characteristic to a second calculation characteristic for calculating the correction amount that can correct a shake at a frequency lower than that of the first calculation characteristic when the second state is transitioned to the third state, and switches a first control characteristic to a second control characteristic having responsiveness higher than that of the first control characteristic when the first state is transitioned to the second state.

### BACKGROUND

### Field of the Technology

The aspect of the disclosure relates to one or more embodiments of a control apparatus, an image pickup apparatus, a lens apparatus, a control method, and a storage medium.

### Description of the Related Art

One conventional method improves image stabilizing performance during exposure by changing the control of an actuator for an image stabilizing unit in an imaging state (during exposure) from the imaging preparation state (live-view (LV) state) to increase responsiveness to camera shake. However, changing the control of the actuator may increase the driving noise of the actuator. In addition, the image stabilizing unit may move minutely when the actuator control is changed. Japanese Patent Application Laid-Open No. 2011-130268 discloses a method of suppressing minute movements of the image stabilizing unit and minute image blurs in captured images by switching a control mode stepwise.

However, the method disclosed in Japanese Patent Application Laid-Open No. 2011-130268 switches the control mode stepwise after receiving an exposure start instruction, and thus causes a time lag (release time lag) between the time when the user issues an exposure start instruction and the time when the actual exposure starts.

### SUMMARY

One or more embodiments of a control apparatus according to one or more aspects of the disclosure may include one or more memories storing instructions, and one or more processors that, upon execution of the instructions, operate to calculate a correction amount for image stabilization using a signal obtained from a shake detector, and control an image stabilizing unit configured to perform the image stabilization based on the correction amount and a control characteristic. The one or more processors have a first calculation characteristic, and a second calculation characteristic for calculating the correction amount that can correct a shake at a frequency lower than that of the first calculation characteristic, and the control characteristic includes a first control characteristic, and a second control characteristic having responsiveness higher than that of the first control characteristic. In a case where a state is transitioned to a first state, a second state, and a third state in this order according to a user instruction, the one or more processors operate to switch the first calculation characteristic to the second calculation characteristic when the second state is transitioned to the third state, and switch the first control characteristic to the second control characteristic when the first state is transitioned to the second state. Alternatively, in a case where a state is transitioned to a second state, a third state, and a fourth state in this order according to a user instruction, the one or more processors operate to gradually switch the second calculation characteristic to the first calculation characteristic when the third state is transitioned to the fourth state, and maintain the second control characteristic in the second state. One or more control methods corresponding to the above one or more control apparatuses also constitute another aspect of the disclosure. A storage medium storing a program that causes a computer to execute the above one or more control methods also constitutes another aspect of the disclosure.

Features of the disclosure will become apparent from the following description of embodiments with reference to the attached drawings. The following description of embodiments is described by way of example.

### BRIEF DESCRIPTION OF THE DRAWINGS

FIGS. 1A and 1B are a central sectional view and a block diagram of an imaging system according to a first embodiment.

FIG. 2 is a block diagram of the image stabilizing system according to the first embodiment.

FIGS. 3A and 3B explain a target generation characteristic according to the first embodiment.

FIGS. 4A and 4B explain a servo control characteristic according to the first embodiment.

FIGS. 5A and 5B explain the conventional switching of each of target generation characteristic and the servo control characteristic.

FIGS. 6A and 6B explain switching of each of the target generation characteristic and the servo control characteristic according to the first embodiment.

FIG. 7 is a flowchart illustrating a control method according to the first embodiment.

FIG. 8 explains the conventional switching of each of the target generation characteristic and the servo control characteristic during continuous shooting.

FIG. 9 explains the conventional switching of each of the target generation characteristic and the servo control characteristic according to a second embodiment.

FIG. 10 is a flowchart illustrating a control method according to the second embodiment.

### DESCRIPTION OF THE EMBODIMENTS

In the following, the term “unit” may refer to a software context, a hardware context, or a combination of software and hardware contexts. In the software context, the term “unit” refers to a functionality, an application, a software module, a function, a routine, a set of instructions, or a program that can be executed by a programmable processor such as a microprocessor, a central processing unit (CPU), or a specially designed programmable device or controller. A memory contains instructions or programs that, when executed by the CPU, cause the CPU to perform operations corresponding to units or functions. In the hardware context, the term “unit” refers to a hardware element, a circuit, an assembly, a physical structure, a system, a module, or a subsystem. Depending on the specific embodiment, the term “unit” may include mechanical, optical, or electrical components, or any combination of them. The term “unit” may include active (e.g., transistors) or passive (e.g., capacitor) components. The term “unit” may include semiconductor devices having a substrate and other layers of materials having various concentrations of conductivity. It may include a CPU or a programmable processor that can execute a program stored in a memory to perform specified functions. The term “unit” may include logic elements (e.g., AND, OR) implemented by transistor circuits or any other switching circuits. In the combination of software and hardware contexts, the term “unit” or “circuit” refers to any combination of the software and hardware contexts as described above. In addition, the term “element,” “assembly,” “component,” or “device” may also refer to “circuit” with or without integration with packaging materials.

Referring now to the accompanying drawings, a detailed description will be given of embodiments according to the disclosure.

### First Embodiment

### Imaging System

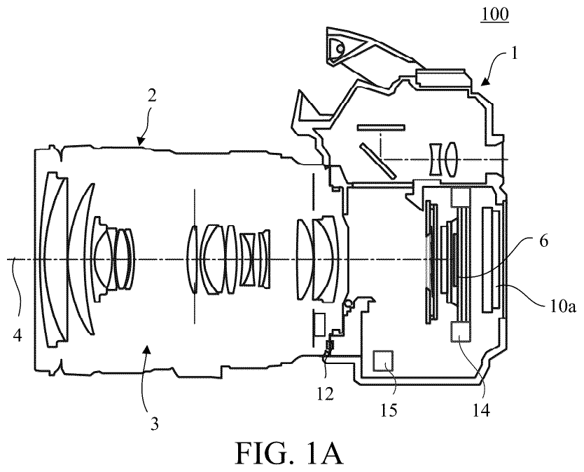

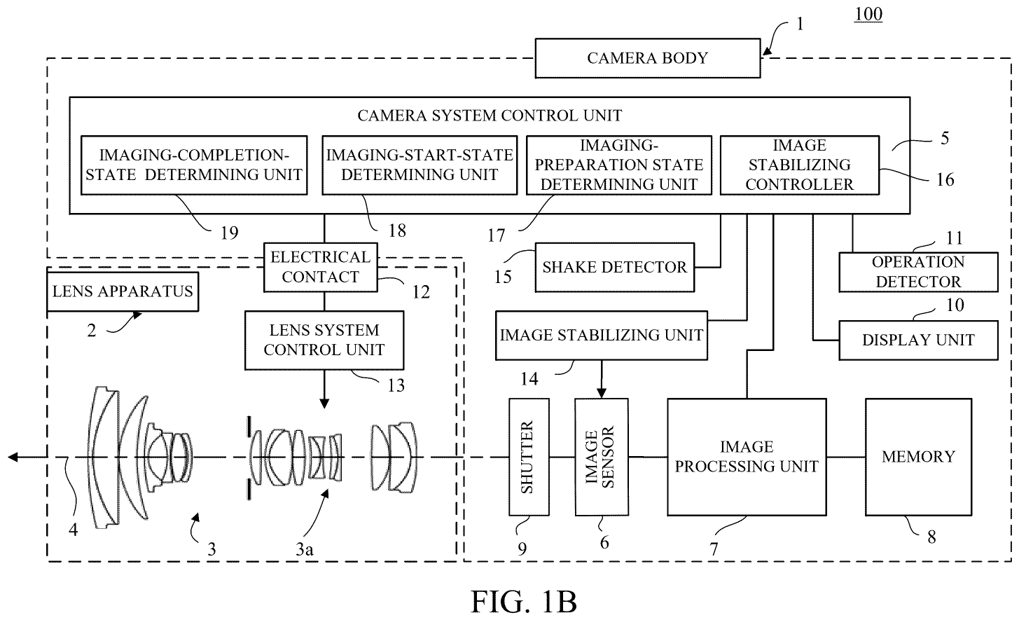

Referring now to FIGS. 1A and 1B, a description will be given of an imaging system 100 according to a first embodiment of the disclosure. FIG. 1A is a central sectional view of the imaging system 100. FIG. 1B is a block diagram illustrating the electrical configuration of the imaging system 100. The same reference numerals are used for common parts in FIGS. 1A and 1B.

The imaging system 100 includes a camera body (image pickup apparatus) 1 and a lens apparatus 2 attachable to and detachable from the camera body 1. However, this embodiment is not limited to this example, and can also be applied to an image pickup apparatus in which the camera body and the lens apparatus are integrated.

In FIGS. 1A and 1B, reference numeral 3 denotes an imaging optical system that includes a plurality of lenses and is provided in the lens apparatus 2. Reference numeral 4 denotes an optical axis of the imaging optical system 3, reference numeral 5 denotes a camera system control unit, reference numeral 6 denotes an image sensor, reference numeral 7 denotes an image processing unit, and reference numeral 8 denotes a memory (unit). Reference numeral 9 denotes a shutter provided in front of the image sensor 6, and reference numeral 10 denotes a display unit. Reference numeral 3a denotes an image stabilizing lens configured to perform image stabilization in the imaging optical system 3. Reference numeral 10a denotes a rear display apparatus provided on the rear surface of the camera body 1. Reference numeral 11 denotes an operation detector configured to detect a signal from an operation unit including a shutter release button (not illustrated) and the like.

Reference numeral 12 denotes an electrical contact for communications between the camera body 1 and the lens apparatus 2, and reference numeral 13 denotes a lens system control unit (control apparatus) provided in the lens apparatus 2. Reference numeral 14 denotes an image stabilizing unit configured to drive the image sensor 6 in a plane orthogonal to the optical axis 4, reference numeral 15 denotes a shake detector configured to detect a shake amount of the camera body 1, and reference numeral 16 denotes an image stabilizing controller provided in the camera system control unit 5. Reference numeral 17 denotes an imaging-preparation-state determining unit configured to determine whether imaging preparation is complete or not. Reference numeral 18 denotes an imaging-start-state determining unit configured to determine whether imaging has been started or not. Reference numeral 19 denotes an imaging-completion-state determining unit configured to determine whether imaging has been completed or not.

The imaging system 100 that includes the camera body 1 and the lens apparatus 2, has an imaging unit, image processor, recording and playback unit, and a controller. The imaging unit includes the imaging optical system 3 and the image sensor 6. The image processor includes the image processing unit 7. The recording and playback unit includes the memory 8 and the display unit 10. The controller includes the camera system control unit 5, the operation detector 11, the shake detector 15, the image stabilizing unit 14, and the lens system control unit 13. In addition to the image stabilizing lens 3a, the lens system control unit 13 can drive an unillustrated focus lens, an unillustrated aperture stop, etc., using an unillustrated drive unit.

The shake detector 15 can detect a rotational shake applied to the camera body 1 relative the optical axis 4, and is realized, for example, by a vibration gyro. The image stabilizing unit 14 drives the image sensor 6 on a plane orthogonal to the optical axis 4 based on the rotational shake amount detected by the shake detector 15.

The shake detector 15 includes, for example, an acceleration sensor and can detect a translational shake applied to the camera body 1. The image stabilizing unit 14 drives the image sensor 6 in a plane orthogonal to the optical axis 4 based on the rotational shake and translational shake detected by the shake detector 15.

The imaging unit is an optical processing system that images light from an object on the imaging surface of the image sensor 6 via the imaging optical system 3. A signal indicating a focus evaluation amount/proper exposure amount is obtained from the image sensor 6. Thus, properly adjusting the imaging optical system 3 based on this signal can expose the image sensor to a proper amount of object light and form an object image near the image sensor 6.

The image processing unit 7 includes an A/D converter, a white balance adjustment circuit, a gamma correction circuit, an interpolation calculation circuit, and the like, and can generate an image for recording. The image processing unit 7 further includes a color interpolation processing unit and performs color interpolation (demosaicing) processing for a Bayer array signal to generate a colored image. The image processing unit 7 also compresses still and moving images, and audio using a predetermined method.

The memory 8 has an actual storage unit storing instructions. The camera system control unit 5 outputs images and the like to the storage unit in the memory 8, and displays an image to be presented to the user on the display unit 10.

The camera system control unit 5 generates and outputs timing signals and the like in capturing images. It controls the imaging system, image processing system, and recording/playback system according to external operations. For example, the operation detector 11 detects the pressing of an unillustrated shutter release button. The camera system control unit 5 controls the driving of the image sensor 6, the operation of the image processing unit 7, compression processing, and the like. The camera system control unit 5 further controls the state of each segment of the information display apparatus that displays information through the display unit 10. The rear display apparatus 10a includes, for example, a touch panel, and may serve as both the display unit 10 and the operation unit.

A description will now be given of the adjustment operation of the optical system by the control system. The camera system control unit 5 is connected to the image processing unit 7, which determines a proper focus position and aperture position based on the signal from the image sensor 6. The camera system control unit 5 issues commands to the lens system control unit 13 via the electrical contact 12, and the lens system control unit 13 properly controls the focus lens drive unit and aperture drive unit (not illustrated).

Next follows a description of the basic operation of the image stabilizing controller 16 included in the camera system control unit 5. First, the camera system control unit 5 detects a camera shake signal (rotational shake and translational shake) detected by the shake detector 15. Based on the result, the camera system control unit 5 calculates a drive amount of the image sensor 6 to correct an image blur. Thereafter, the camera system control unit 5 outputs a calculated drive amount to the image stabilizing unit 14 as a command value to drive the image sensor 6.

In this embodiment, in addition to the above control, the camera system control unit 5 changes the control of the image stabilizing unit 14 according to an imaging state obtained from the imaging-preparation-state determining unit 17, the imaging-start-state determining unit 18, and the imaging-completion-state determining unit 19, etc. The detailed control method will be described later.

As mentioned above, the camera system control unit 5 and the lens system control unit 13 control the operation of each part of the camera body 1 and the lens apparatus 2 according to user operation on the unillustrated operation unit provided in the camera body 1 and the lens apparatus 2. Thereby, still and moving images can be captured.

In this embodiment, the camera body 1 includes the image stabilizing unit 14, but the image stabilizing unit 14 may be included in the lens apparatus 2 or in each of the camera body 1 and the lens apparatus 2. The camera system control unit 5 can obtain the effects of this embodiment by controlling the image stabilizing unit 14 in a similar manner as described later.

### Control of Image Stabilizing System

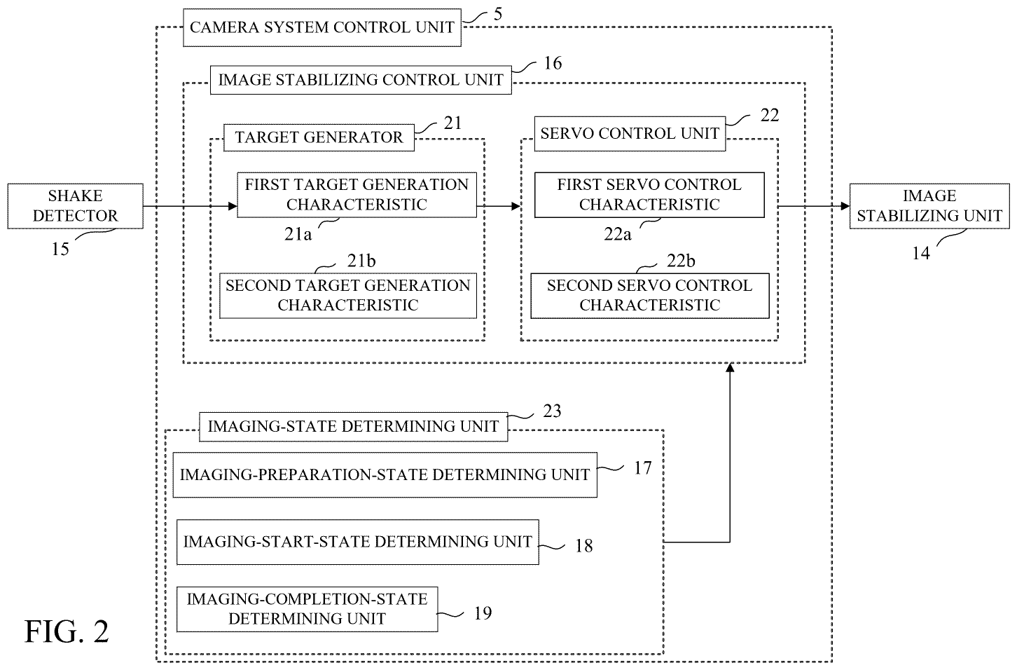

Referring now to FIG. 2, a detailed description will be given of the camera system control unit 5 according to this embodiment. FIG. 2 is a control block diagram of the image stabilizing system (shake detector 15, camera system control unit 5, and image stabilizing unit 14) provided in the camera body 1. In particular, the operation of the image stabilizing controller 16 will be described here. The image stabilizing controller 16 generates a control target value (target) corresponding to a correction amount to be used for image stabilization from the camera shake signal obtained from the shake detector 15, and calculates a drive control amount for servo-controlling the image stabilizing unit 14 based on the target.

In FIG. 2, reference numeral 21 denotes a target generator (correction amount calculator configured to calculate a correction amount for image stabilization) configured to generate (calculate) the control target value (target) to be used for image stabilization from the camera shake signal obtained from the shake detector 15 in the image stabilizing controller 16. More specifically, the target generator 21 includes a high-pass filter and a gain compensator based on the characteristic of the shake detector 15, an integrator configured to process the angular velocity signal obtained from the shake detector 15, and the like.

Reference numeral 22 denotes a servo control unit (a controller (one or more processors that, upon execution of instructions which one or more memories store) configured to control the image stabilizing unit 14 configured to perform image stabilization based on the correction amount for image stabilization and control characteristic) that calculates a drive control amount for servo-controlling the image stabilizing unit 14 based on the target generated by the target generator 21. More specifically, the servo control unit 22 is a PID controller that calculates a drive control amount for the image stabilizing unit 14 based on the target generated by the target generator 21. The PID controller calculates a drive control amount for the image stabilizing unit 14 with reference to a position detection result (position information) of an image stabilizing member position detector (not illustrated) that detects the position of the image stabilization member (image sensor 6) for the target generated by the target generator 21. Reference numeral 23 denotes an imaging-state determining unit. The imaging-state determining unit 23 includes an imaging-preparation-state determining unit 17, an imaging-start-state determining unit 18, and an imaging-completion-state determining unit 19.

The target generator 21 has a first target generation characteristic (first calculation characteristic) 21a and a second target generation characteristic (second calculation characteristic) 21b, and changes the target generation characteristic by referring to the imaging state obtained from the imaging-state determining unit 23. Similarly, the servo control unit 22 has a first servo control characteristic (first control characteristic) 22a and a second servo control characteristic (second control characteristic) 22b, and changes the servo control characteristic by referring to the imaging state obtained from the imaging-state determining unit 23.

The target generated by the first target generation characteristic 21a (first calculation characteristic) has a characteristic more suitable for image stabilization in the imaging preparation state than that of the target generated by the second target generation characteristic 21b (second calculation characteristic). More specifically, the first target generation characteristic 21a has a time constant of a high-pass filter set higher than that of the second target generation characteristic 21b. In addition, regarding the characteristic of the integrator, the first target generation characteristic 21a may be an integrator with imperfect integration, whereas the second target generation characteristic 21b may be an integrator with perfect integration.

Generally, in the imaging preparation state in which framing operations and the like are performed, the user performs an operation that significantly moves the camera body 1, which is called panning. In such a case, in a case where image stabilization is performed (the image stabilizing unit 14 is operated) to cancel out the framing operation, the user cannot perform the intended framing. Hence, image stabilization may not be performed in a relatively low frequency band such as the movement during the framing operation. In this embodiment, such a framing operation and panning operation correspond to the imaging preparation operation. However, this embodiment is not limited to this example, and another operation is also included in the imaging preparation operation as long as it is performed by the user before actually exposure (imaging) of the image sensor 6.

Thus, the target generator 21 applies a high-pass filter to the camera shake signal obtained from the shake detector 15 as in the first target generation characteristic 21a, thereby excluding low-frequency movements such as the user's framing operation from the correction target for image stabilization. The integrator may use imperfect integration with the first target generation characteristic 21a.

On the other hand, during the imaging period of the image sensor 6 (during the exposure of the image sensor 6), as much camera shake detected by the shake detector 15 may be removed as possible. Thus, the target generator 21 uses a filter with a lower high-pass filter time constant than that of the first target generation characteristic 21a, as in the second target generation characteristic 21b. The integrator may use perfect integration with the second target generation characteristic 21b.

The first servo control characteristic 22a (first control characteristic) has a characteristic more suitable for the imaging preparation state than that of the second servo control characteristic 22b (second control characteristic); more specifically, the responsiveness of the image stabilizing unit 14 is set low, and the driving noise is small.

In general, the camera body 1 may be quiet. On the other hand, in an attempt to improve the image stabilizing performance, in a case where the high-frequency servo control performance is improved and the responsiveness of the image stabilizing unit 14 is increased to correct high-frequency camera shake, the driving noise of the actuator may increase accordingly. On the other hand, the image stabilizing performance is most necessary during the actual imaging period (the exposure period of the image sensor 6), and in contrast, in the imaging preparation state before imaging in which imaging is not intended, the driving noise of the actuator may be small. Thereby, the user can perform imaging preparation such as framing without being bothered by the driving noise of the actuator, and also the power consumption of the actuator can be reduced.

Thus, the second servo control characteristic 22b has a characteristic that improves the servo control performance at a high frequency and the responsiveness of the image stabilizing unit 14 in the high frequency band is high in comparison with the first servo control characteristic 22a.

The imaging-state determining unit 23 includes the imaging-preparation-state determining unit 17, the imaging-start-state determining unit 18, and the imaging-completion-state determining unit 19. The imaging-preparation-state determining unit 17 determines that imaging preparation has been started, for example, by determining that the shutter release button has been half-pressed (S1) by the user. The imaging-start-state determining unit 18 determines that imaging has been started, for example, by determining that the shutter release button has been fully pressed (S2). The imaging-completion-state determining unit 19 determines that imaging has been completed, for example, by determining whether the exposure of the image sensor 6 has been completed. As described above, the state is transitioned to an imaging standby state (first state), an imaging preparation state (second state), an imaging start state (third state), and an imaging completion state (fourth state) in this order according to a user instruction (command).

The determination methods of the imaging-preparation-state determining unit 17, the imaging-start-state determining unit 18, and the imaging-completion-state determining unit 19 are not limited to the above methods, and may be other methods. In this embodiment, the imaging-preparation-state determining unit 17 uses a method of determining whether imaging preparation has been started by determining the half-pressed state (S1) of the shutter release button. However, the determination method of the imaging-preparation-state determining unit 17 may be determined based on the auto-exposure (AE) (photometry or light metering) start timing or an autofocus (AF) (focus detection) start timing other than the half-pressed state of the shutter release button. A light metering unit (photometric unit) may be provided and the imaging preparation state may be determined using the AE start timing of the light metering unit, or a focus detector may be provided and the imaging preparation state may be determined using the AF start timing of the focus detector.

### Difference in Servo Control Characteristic

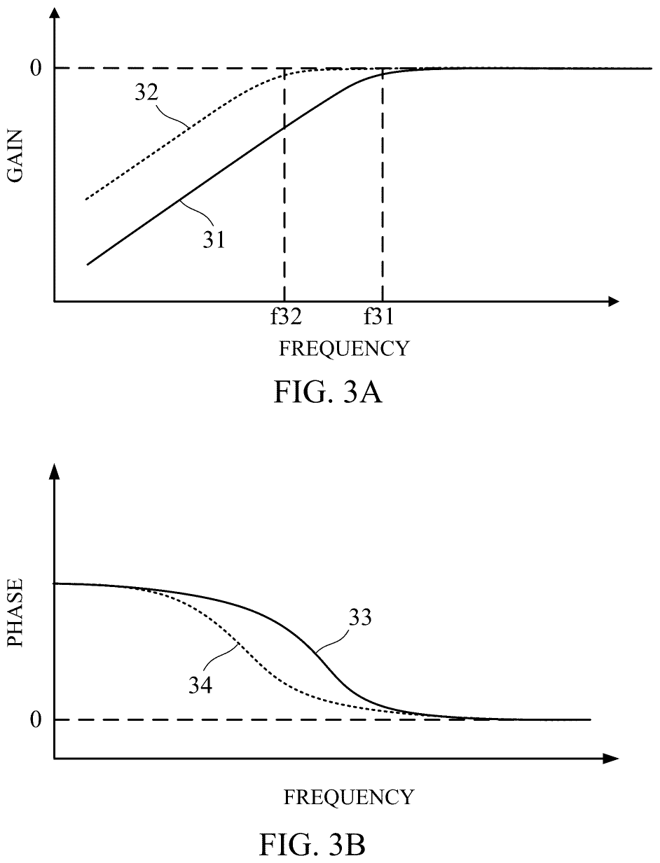

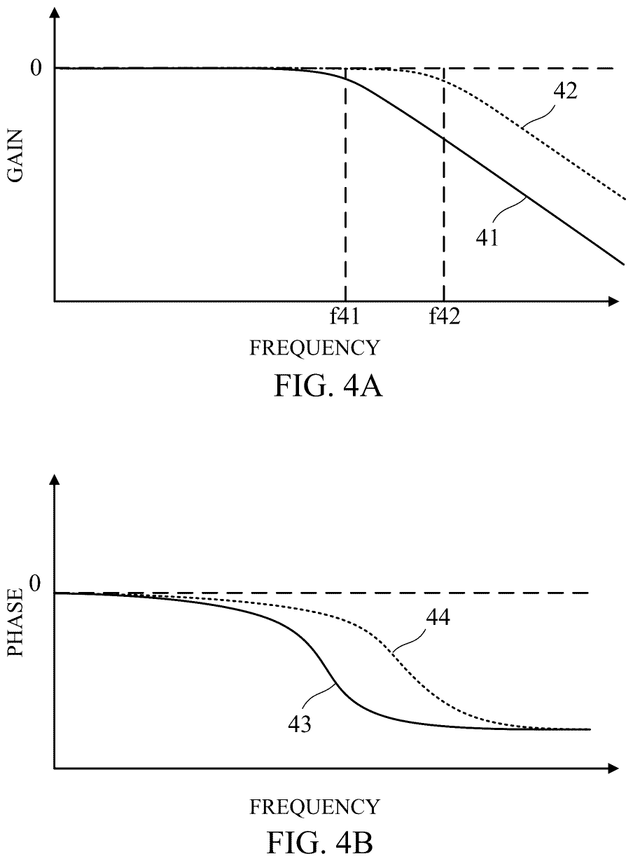

Referring now to FIGS. 3A, 3B, 4A, and 4B, a description will be given of a characteristic difference between the target generator 21 and the servo control unit 22. FIGS. 3A and 3B explain a target generation characteristic in the target generator 21. In FIG. 3A, the horizontal axis represents frequency, and the vertical axis represents gain. In FIG. 3B, the horizontal axis represents frequency, and the vertical axis represents phase. In FIG. 3A, reference numeral 31 denotes a gain characteristic of the first target generation characteristic 21a, and reference numeral 32 denotes a gain characteristic of the second target generation characteristic 21b. In FIG. 3B, reference numeral 33 denotes a phase characteristic of the first target generation characteristic 21a, and reference numeral 34 denotes a phase characteristic of the second target generation characteristic 21b.

As described with reference to FIG. 2, the first target generation characteristic 21a uses a filter with a higher high-pass time constant than that of the second target generation characteristic 21b. Therefore, as illustrated in FIG. 3A, the break point frequency f31 of the gain characteristic 31 is set higher than the break point frequency f32 of the gain characteristic 32, and the characteristic is such that relatively low frequencies are cut. Similarly, the break point frequency of the phase characteristic 33 is set higher than that of the phase characteristic 34. Here, the break point frequency is a frequency corresponding to the break point (folded point) of the gain characteristic, and corresponds to the angular frequency ω=1/T.

Due to these effects, interference of the user's the framing operation with the operation on the camera body 1 can be prevented without the image stabilization in the imaging preparation state, such as a framing operation, which has no intention of imaging. On the other hand, during the imaging period of the image sensor 6 (during exposure of the image sensor 6 that has an imaging intent), image stabilization is performed up to a sufficiently low frequency and a good imaging result with little image blur can be obtained.

FIGS. 4A and 4B explain the servo control characteristic in the servo control unit 22. In FIG. 4A, the horizontal axis represents frequency and the vertical axis represents gain. In FIG. 4B, the horizontal axis represents frequency and the vertical axis represents phase. In FIG. 4A, reference numeral 41 denotes a gain characteristic of the first servo control characteristic 22a, and reference numeral 42 denotes a gain characteristic of the second servo control characteristic 22b. In FIG. 4B, reference numeral 43 denotes a phase characteristic of the first servo control characteristic 22a, and reference numeral 44 denotes a phase characteristic of the second servo control characteristic 22b.

As described with reference to FIG. 2, the second servo control characteristic 22b is a characteristic that improves the servo control performance at high frequencies and increases the responsiveness of the image stabilizing unit 14 compared to the first servo control characteristic 22a. Therefore, as illustrated in FIG. 4A, the break point frequency f42 of the gain characteristic 42 is set higher than the break point frequency f41 of the gain characteristic 41, and is a characteristic that allows the image stabilizing unit 14 to respond up to relatively high frequencies. Similarly, compared to the phase characteristic 43, the phase characteristic 44 also has less delay up to high frequencies, and is a characteristic that allows the image stabilizing unit 14 to respond up to relatively high frequencies. Accordingly, the first servo control characteristic 22a has a quieter characteristic with less driving noise of the actuator than that of the second servo control characteristic 22b.

Due to these effects, during the period during imaging of the image sensor 6 (during exposure of image sensor 6 that has an imaging intent), a good imaging result with a less image blur by performing image stabilization up to sufficiently high frequencies. At the same time, the imaging preparation state that has no imaging intent, such as a framing operation, can maintain the quality of the camera body 1 by preventing the actuator noise from being heard during the user operation.

### Control Characteristic Switching Method

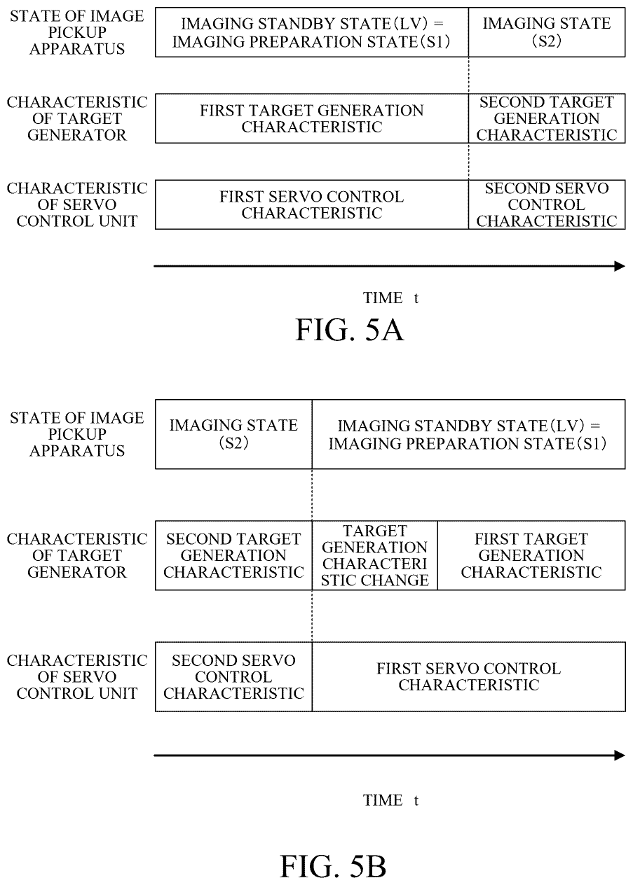

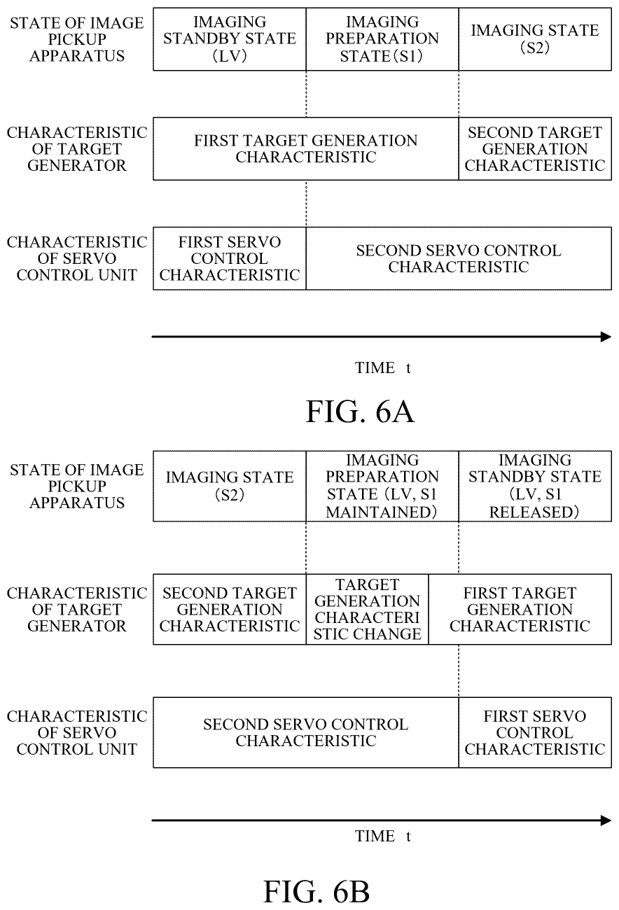

Referring now to FIGS. 5A, 5B, 6A, and 6B, a description will be given of the switching method of each of the target generator 21 and the servo control unit 22. FIGS. 5A and 5B explain the conventional switching of each of the target generation characteristic and the servo control characteristic. FIG. 5A illustrates the switching of each of the target generation characteristic and the servo control characteristic at the imaging start. FIG. 5B illustrates the switching of each of the target generation characteristic and the servo control characteristic at the imaging end. In both FIGS. 5A and 5B, the horizontal axis represents time t, and the vertical axis illustrates a state change of the camera body 1, a characteristic change of the target generator, and a characteristic change of the servo control unit as time passes from left to right.

Conventionally, each of the target generation characteristic and the servo control characteristic is switched only according to an imaging state change, i.e., whether or not the imaging state (exposure state of the image sensor 6) is in progress. Therefore, at the imaging start as illustrated in FIG. 5A, when the imaging standby state (so-called LV state) is changed to the imaging preparation state (S1 state), each of the target generation characteristic and the servo control characteristic is not switched. That is, image stabilization control is performed using the first target generation characteristic and the first servo control characteristic. Thereafter, at the timing of switching to the imaging state (S2 state), the characteristic is switched to the second target generation characteristic and the second servo control characteristic, and image stabilization control during exposure is performed. In changing the servo control characteristic, the image stabilizing unit 14 may move minutely unintentionally due to the control change, and this minute movement of the image stabilizing unit 14 affects a captured image, causing a minute image blur.

Similarly, at the imaging completion illustrated in FIG. 5B, at the timing of completing the imaging state (S2 state), the second target generation characteristic is switched to the first target generation characteristic, and the second servo control characteristic is switched to the first servo control characteristic. In changing from the second target generation characteristic to the first target generation characteristic, the target generator may be designed to gradually and smoothly switch to the first target generation characteristic rather than all the way in one go. Simultaneously calculating both the first target generation characteristic and the second target characteristic and gradually switching after imaging can prevent a sudden change in an image displayed on the EVF after imaging (a sudden change in an angle of view).

On the other hand, due to the characteristic of the integrator, the second target generation characteristic has a characteristic that the signal starts changing with the exposure start. Therefore, even if the first target generation characteristic is switched to the second target generation characteristic at the exposure start, a sudden change in the angle of view does not occur. Accordingly, an operation may be performed in which the target generation characteristic is gradually changed only when exposure is completed.

FIGS. 6A and 6B explain the switching of each of the target generation characteristic and the servo control characteristic according to this embodiment. FIG. 6A illustrates the switching of each of the target generation characteristic and the servo control characteristic at the imaging start. FIG. 6B illustrates the switching of each of the target generation characteristic and the servo control characteristic at the imaging end. In both FIGS. 6A and 6B, the horizontal axis represents time t, which passes from left to right, and how each of the state of the camera body 1, the characteristic of the target generator, and the characteristic of the servo control unit changes over time is illustrated.

This embodiment switches each of the target generation characteristic and the servo control characteristic according to imaging state changes determined by the imaging-preparation-state determining unit 17, the imaging-start-state determining unit 18, and the imaging-completion-state determining unit 19.

At the imaging start illustrated in FIG. 6A, the imaging intent is determined when the state changes from the imaging standby state (LV state) to the imaging preparation state (S1 state), and the first servo control characteristic 22a is first switched to the second servo control characteristic 22b. Thereafter, when the state is switched to the imaging state (S2 state), the first target generation characteristic 21a is switched to the second target generation characteristic 21b.

Switching each of the target generation characteristic and the servo control characteristic in this way can maintain quietness in the imaging standby state (LV state). In the imaging preparation state (S1), the first target generation characteristic 21a does not hinder the user's framing operation (because low-frequency camera shake is not corrected). In addition, the second servo control characteristic 22b allows for correction of camera shake (high-frequency camera shake) to be removed even in the imaging preparation state, and can provide a comfortable framing operation. In the imaging state (S2 state), the second target generation characteristic 21b can properly correct low-frequency camera shake. At the same time, the servo control characteristic has already been switched to the second servo control characteristic 22b, so that the minute movement of the image stabilizing unit 14 does not affect the image captured by changing the servo control characteristic, and minute blurring does not occur. The imaging standby state may be a state in which a live-view image is displayed on the display unit but as long as the shutter release button is not half-pressed, the display unit that displays the live-view image may be the display unit 10 or a display unit of an external device.

At the imaging completion illustrated in FIG. 6B, when the imaging state (S2 state) is completed and the state changes to the imaging preparation state (LV state and S1 state), the second target generation characteristic 21b is first switched to the first target generation characteristic 21a. Thereafter, the imaging preparation state (LV state and S1 state) is released and switched to the imaging standby state (LV state and S1 released state), the imaging intent is no longer determined, and the second servo control characteristic 22b is switched to the first servo control characteristic 22a.

Switching each of the target generation characteristic and the servo control characteristic in this way can maintain the second servo control characteristic 22b even after imaging is completed, as long as the shutter release button is kept half-pressed (LV state and S1 state are maintained). Therefore, even when the imaging state (S2 state) is again set from the imaging preparation state (LV state and S1 state), imaging can be started without changing the servo control characteristic, so that imaging can be started without a release time lag. In a case where the imaging preparation state (LV state and S1 state) is released and switched to the imaging standby state (LV state and S1 released state), the second servo control characteristic 22b is switched to the first servo control characteristic 22a, and thereby quietness can be maintained in the imaging standby state again.

As with the conventional technology, in changing from the second target generation characteristic 21b to the first target generation characteristic 21a, the target generator does not change suddenly but gradually switches to the first target generation characteristic. During this change, when the imaging state (S2 state) is set again, the target generator switches again to the second target generation characteristic 21b.

As described with reference to FIG. 2, the determination methods of the imaging-preparation-state determining unit 17, the imaging-start-state determining unit 18, and the imaging-completion-state determining unit 19 are not limited to the above methods and may be other methods. In this embodiment, the imaging-preparation-state determining unit 17 uses a method of determining whether imaging preparation has been started by determining whether the shutter release button is half-pressed (S1). However, the imaging-preparation-state determining unit 17 may use a method other than the half-pressed state of the shutter release button, such as the AE (light metering) start timing or the AF (focus detecting) start timing.

For example, consider a case where the camera body 1 includes a light metering unit, and the AE (light metering) start timing is used as the imaging-preparation-state determining unit 17. In that case, at the imaging start, the state of the camera body 1 is changed from the imaging standby state to the imaging preparation state by an AE start operation, and the first servo control characteristic 22a is changed to the second servo control characteristic 22b. At the imaging end, the imaging preparation state ends and the state of the camera body 1 changes to the imaging standby state in a case where the AE lock ends, or in a case where an AE operation is performed and no input is made for a predetermined period, and the second servo control characteristic 22b is changed to the first servo control characteristic 22a. Alternatively, if the AF mode is the servo AF mode, the AF operation period may be determined to be the imaging preparation state, and a method of changing the servo control characteristic may be used, such as maintaining the second servo control characteristic 22b during the AF operation period.

Characteristic Switching of Servo Control Unit Using Method Other than S1

In FIG. 6A, an example is illustrated in which the state of the camera body 1 transitions from the imaging standby state (LV state) to the imaging state (S2 state) through the imaging preparation state (S1 state), but the imaging standby state (LV) state may transition to the imaging state (S2 state) all the way in one go. In other words, the user may press the shutter release button all the way in one go, and the exposure of the image sensor 6 may start immediately from the imaging standby state (LV state). In such a case, several methods are conceivable for changing each of the target generation characteristic and the servo control characteristic.

The first method can start the exposure of the image sensor 6 as soon as possible when the state of the camera body 1 changes to the imaging state (S2 state). In that case, the servo control unit 22 maintains the first servo control characteristic 22a even after the exposure of the image sensor 6 starts, and at the same time, the target generator 21 changes the target generation characteristic from the first target generation characteristic 21a to the second target generation characteristic 21b. Thereafter, when imaging is completed, the imaging-preparation-state determining unit 17 determines whether the imaging preparation state is maintained, and if the imaging preparation state is maintained, the servo control unit 22 operates to change the servo control characteristic from the first servo control characteristic 22a to the second servo control characteristic 22b.

In the second method, image stabilizing performance is prioritized and the change of the servo control characteristic is prioritized even if there is a release time lag. When the state of the camera body 1 changes to the imaging state (S2 state), it is considered that the state has also changed to the imaging preparation state (S1 state) at the same time, and the servo control unit 22 changes the servo control characteristic from the first servo control characteristic 22a to the second servo control characteristic 22b. At the same time, the target generator 21 changes the target generation characteristic from the first target generation characteristic 21a to the second target generation characteristic 21b. At that time, if the change of the servo control characteristic is likely to cause a minute movement in the image stabilizing unit 14, exposure of the image sensor 6 is started a short time after the servo control characteristic is changed. Thereafter, when imaging is completed, the imaging-preparation-state determining unit 17 determines whether the imaging preparation state is maintained, and if the imaging preparation state is maintained, the servo control characteristic operates to maintain the second servo control characteristic.

As another method, the first method and the second method may be selectable by the user. For example, an unillustrated control characteristic selector that enables the user to select the control characteristic may be provided, and the user can select between a case in which priority is given to the speed at which the exposure of the image sensor 6 is started (first method) and a case in which priority is given to image stabilizing performance (second method). In other words, the first method and the second method may be changed according to the user's selection (setting).

The camera body 1 may include a shutter speed selector, and the first method and the second method may be changed according to the shutter speed set by the shutter speed selector. For example, in a case where the shutter speed is high, the first method may be selected with priority given to reducing the occurrence of release time lag, and in a case where the shutter speed is low, the second method may be selected with priority given to image stabilizing performance even if some release time lag occurs. Conversely, in a case where the shutter speed is high, a high-frequency blur is dominant in an image to be captured, so in order to suppress the occurrence of high-frequency blur, the second method may be adopted to prioritize the change in the servo control characteristic. In this case, in a case where the shutter speed is low, it is assumed that high-frequency blur is not very noticeable in the image, and the first method is adopted.

### Timing of Switching Servo Control Characteristic

In FIGS. 6A and 6B, the servo control unit 22 switches the servo control characteristic according to the determination result of the imaging-preparation-state determining unit 17, but in switching the servo control characteristic, it is also possible to refer to the position information on the image stabilizing unit 14, etc. In other words, the servo control unit 22 may use the position information on the image stabilizing unit 14 to determine whether or not to switch the first servo control characteristic 22a to the second servo control characteristic 22b.

As discussed, when the servo control unit 22 changes the servo control characteristic, the image stabilizing unit 14 may move minutely, which may negatively affect the image. In a case where such an event occurs at the exposure start, influence on a captured image, such as a minute blur, may occur but if this minute blur occurs in transitioning to the imaging preparation state, the LV image may move minutely in a short period of time. Thereby, quality problems may occur such as the LV image not appearing good. Hence, the image stabilizing unit 14 may not move minutely in changing the servo control characteristic.

Minute movements in changing the servo control characteristic may occur in a case where there is a large difference between the target signal generated by the target generator 21 and the position of the image stabilizing unit 14 controlled by the servo control unit 22. This is because a control amount proportional to the difference between the target signal generated by the target generator 21 and the position signal of the image stabilizing unit 14 is input into an actuator as the control amount of the image stabilizing unit 14 to perform servo control.

Accordingly, the image stabilizing unit 14 may include a position detector for acquiring position information on the image stabilizing unit 14. The servo control characteristic of the servo control unit 22 may be switched according to the output of the position detector of the image stabilizing unit 14 in addition to the determination result of the imaging-preparation-state determining unit 17.

More specifically, the target signal generated by the target generator 21 and the position information signal of the image stabilizing unit 14 controlled by the servo control unit 22 obtained from the image-stabilizing-unit position detector are referenced to. In a case where the difference between the target signal and the position information signal is smaller than a predetermined value, the servo control characteristic of the servo control unit 22 is switched. In other words, the target signal of the image stabilizing unit 14 obtained from the first target generation characteristic 21a or the second target generation characteristic 21b is compared with the output of the image-stabilizing-unit position detector, and if the difference is smaller than a predetermined value, the servo control characteristic is switched. Thus, the minute movement of the image stabilizing unit 14 can be suppressed in changing the servo control characteristic, and to change the servo control characteristic with good quality.

### Control Method

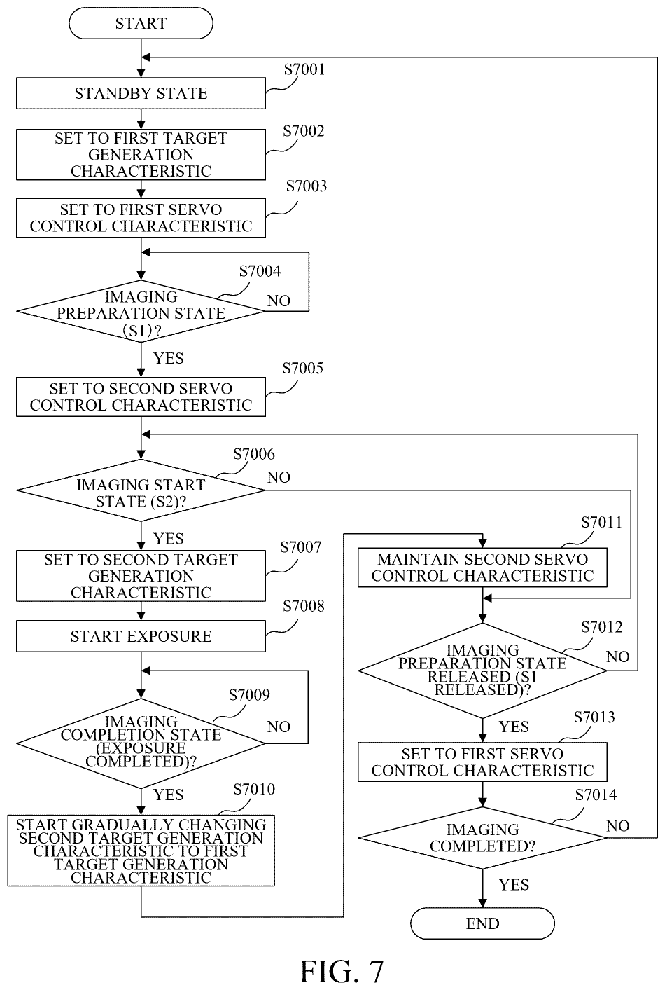

Referring now to FIG. 7, a description will be given of a control method of the imaging system 100 according to this embodiment. FIG. 7 is a flowchart illustrating the control method according to this embodiment. This flow starts in a case where the camera body 1 is powered on.

First, in step S7001, the camera system control unit 5 puts the camera body 1 into an imaging standby state. In the imaging standby state, a so-called LV state is established, and an image captured by the image sensor 6 is displayed in real time on the display unit 10.

Next, in step S7002, the camera system control unit 5 sets the target generation characteristic of the target generator 21 to the first target generation characteristic 21a using the image stabilizing controller 16. Next, in step S7003, the camera system control unit 5 sets the servo control characteristic of the servo control unit 22 to the first servo control characteristic 22a using the image stabilizing controller 16.

Next, in step S7004, using the imaging-preparation-state determining unit 17, the camera system control unit 5 determines whether or not the user has input an imaging preparation start instruction (so-called half-pressing of the shutter release button, S1). In a case where the imaging preparation state is determined, the flow proceeds to step S7005. On the other hand, in a case where the imaging preparation state is not determined, the flow waits and repeats the determination of step S7004.

In step S7005, the camera system control unit 5 sets the servo control characteristic of the servo control unit 22 to the second servo control characteristic 22b using the image stabilizing controller 16. Next, in step S7006, the camera system control unit 5 determines whether or not the user has input an imaging start instruction (so-called full pressing of the shutter release button, S2) using the imaging-start-state determining unit 18. In a case where the imaging start state is determined, the flow proceeds to step S7007. On the other hand, in a case where the imaging start state is not determined, the flow proceeds to step S7012.

In step S7007, the camera system control unit 5 sets the target generation characteristic of the target generator 21 to the second target generation characteristic 21b using the image stabilizing controller 16. Next, in step S7008, the camera system control unit 5 starts exposure using the image sensor 6. Next, in step S7009, the camera system control unit 5 determines whether or not exposure by the image sensor 6 is completed, using the imaging-completion-state determining unit 19. In a case where it is determined that the exposure has been completed, the flow proceeds to step S7010. On the other hand, in a case where it is determined that the exposure has not yet been completed, the flow waits and repeats the determination of step S7009.

In step S7010, the camera system control unit 5 gradually switches the target generation characteristic of the target generator 21 from the second target generation characteristic 21b to the first target generation characteristic 21a, using the image stabilizing controller 16. Next, in step S7011, the camera system control unit 5 maintains the servo control characteristic of the servo control unit 22 at the second servo control characteristic 22b using the image stabilizing controller 16.

In step S7012, the camera system control unit 5 determines whether or not the user has input an imaging preparation state start (so-called release of half-pressing of the shutter release button, S1 release) using the imaging-preparation-state determining unit 17. In a case where the imaging preparation state is determined, the flow proceeds to step S7013. On the other hand, in a case where the imaging preparation state is not determined, the flow returns to step S7006.

In step S7013, the camera system control unit 5 switches the servo control characteristic of the servo control unit 22 to the first servo control characteristic 22a using the image stabilizing controller 16. Next, in step S7014, the camera system control unit 5 determines whether or not to end the imaging based on the user's input, etc. In a case where it is determined that the imaging is to end, this flow ends. On the other hand, in a case where it is determined that the imaging is not to end, the flow returns to step S7001.

In FIG. 7, the camera system control unit 5 controls the imaging system 100 in each control flow, but this embodiment is not limited to this example. For example, the lens system control unit 13 may control the imaging system 100 in each control flow.

The image stabilizing unit 14 described as the control target in this embodiment is provided in the camera body 1, but this embodiment is not limited to this example. The image stabilizing unit may be provided in the lens apparatus 2, for example, or may be provided in both the camera body 1 and the lens apparatus 2. In a case where an image stabilizing unit is provided in the lens apparatus 2, a target of the control flow described with reference to FIG. 7 is the image stabilizing unit provided in the lens apparatus 2. In a case where an image stabilizing unit is provided in both the camera body 1 and the lens apparatus 2, a target of the control flow described with reference to FIG. 7 is at least one of the image stabilizing units.

As described above, the control apparatus (camera system control unit 5) according to this embodiment includes a target generator 21 and a servo control unit 22. The target generator 21 generates a target (control target value) for image stabilization using a signal obtained from the shake detector 15. The servo control unit 22 calculates a control amount of the image stabilizing unit 14 that performs image stabilization based on the target. The target generator 21 has a first target generation characteristic 21a and a second target generation characteristic 21b for calculating a correction amount that can correct low-frequency shake compared to the first target generation characteristic 21a. The servo control unit 22 has a first servo control characteristic 22a and a second servo control characteristic 22b having higher responsiveness than that of the first servo control characteristic 22a. The target generator 21 switches the first target generation characteristic 21a to the second target generation characteristic 21b in a case where the imaging state transitions from an imaging preparation state to an imaging start state. The servo control unit 22 switches the first servo control characteristic 22a to the second servo control characteristic 22b in a case where the imaging state transitions from an imaging standby state to an imaging preparation state.

Alternatively, in the control apparatus according to this embodiment, the target generator 21 may gradually switch the second target generation characteristic 21b to the first target generation characteristic 21a in a case where the imaging state transitions from an imaging start state to an imaging completion state. The servo control unit 22 may maintain the second servo control characteristic 22b while the imaging state is in the imaging preparation state.

The first servo control characteristic 22a and the second servo control characteristic 22b may have mutually different breakpoint frequencies of the gain characteristics. The second servo control characteristic 22b may have a higher breakpoint frequency than that of the first servo control characteristic 22a.

The second servo control characteristic 22b may have less delay in the phase characteristic than that of the first servo control characteristic 22a. The first target generation characteristic 21a may have a gain cut in the low frequency band compared to the second target generation characteristic 21b. The imaging preparation state may be a state in which the shutter release button is half-pressed, a state in which the light metering unit is performing a light metering operation, or a state in which the focus detector is performing a focus detecting operation.

As described above, this embodiment changes each of the target generation characteristic and the servo control characteristic according to the determination results of the imaging-preparation-state determining unit 17, the imaging-start-state determining unit 18, and the imaging-completion-state determining unit 19. This configuration can capture an image with high image stabilizing performance just after imaging starts, while quieting down the driving noise of the image stabilizing unit during a period with no imaging intent.

### Second Embodiment

Next follows a description of a second embodiment according to the disclosure. In this embodiment, an imaging mode of the imaging system 100 is a continuous shooting mode. In this embodiment, the basic configuration of the imaging system 100 is similar to that of the first embodiment described with reference to FIGS. 1 and 2, so only the parts that are different from the first embodiment will be described, and a description common to the first embodiment will be omitted.

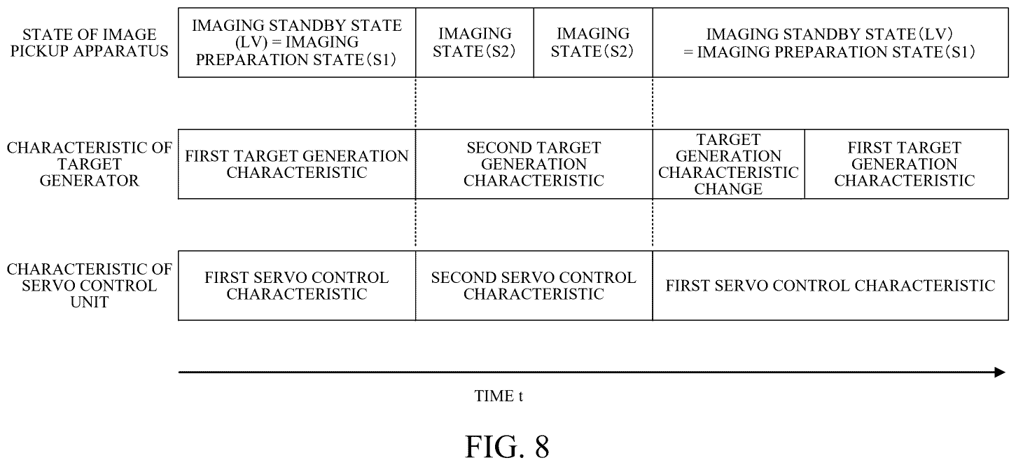

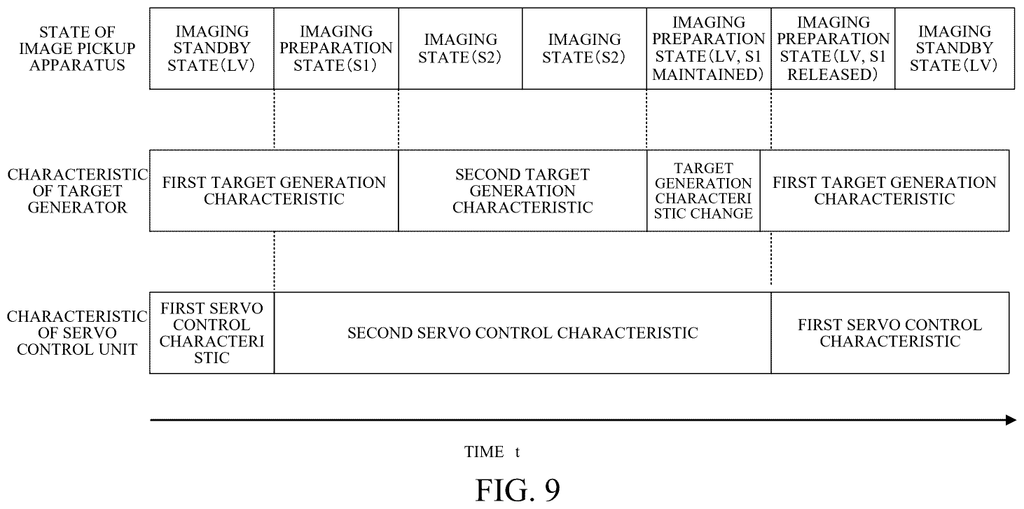

Referring now to FIGS. 8 and 9, a description will be given of a method of switching each of the target generator 21 and the servo control unit 22 in a case where the continuous shooting mode is set. FIG. 8 explains the conventional switching of each of the target generation characteristic and servo control characteristic from the imaging start to the imaging end in the continuous shooting mode. As with FIGS. 5A and 5B, in FIG. 8, the horizontal axis represents time t, and the vertical axis illustrates a state change of the camera body 1, a characteristic change of the target generator, and a characteristic change of the servo control unit as time passes from left to right on the horizontal axis.

As with the cases of FIGS. 5A and 5B, each of the target generation characteristic and the servo control characteristic has conventionally been switched only according to a state change, i.e., whether or not it is an imaging state (exposure state of the image sensor 6). Therefore, as illustrated in FIG. 8, in a case where the imaging standby state (the so-called LV state) is changed to the imaging preparation state (S1 state), each of the target generation characteristic and the servo control characteristic is not switched. That is, image stabilization control is performed using the first target generation characteristic and the first servo control characteristic. Next, when the imaging preparation state is changed to the imaging state (S2 state), they are switched to the second target generation characteristic and the second servo control characteristic, and the image stabilization control during exposure is performed. In a case where the servo control characteristic is changed, the image stabilizing unit 14 may move minutely unintentionally due to the control change, and the minute movement of the image stabilizing unit 14 may affect the captured image, causing a minute image blur.

At the completion of the continuous shooting, the second target generation characteristic is switched to the first target generation characteristic, and the second servo control characteristic is switched to the first servo control characteristic when the imaging state (S2 state) is completed. In changing from the second target generation characteristic to the first target generation characteristic, the target generator may be designed to gradually and smoothly switch to the first target generation characteristic rather than all the way in one go.

FIG. 9 explains a series of switching of each of the target generation characteristic and servo control characteristic from the imaging start to the imaging end in the continuous shooting mode according to this embodiment. As with FIGS. 6A and 6B, in FIG. 9, the horizontal axis represents time t, and the vertical axis illustrates a state change of the camera body 1, a characteristic change of the target generator, and a characteristic change of the servo control unit as time passes from left to right.

This embodiment switches each of the target generation characteristic and the servo control characteristic according to a change in the imaging state determined by the imaging-preparation-state determining unit 17, the imaging-start-state determining unit 18, and the imaging-completion-state determining unit 19. As illustrated in FIG. 9, at the imaging start, it is determined that the user has an imaging intent when the state changes from the imaging standby state (LV state) to the imaging preparation state (S1 state), and first, the first servo control characteristic 22a is switched to the second servo control characteristic 22b. Thereafter, in a case where the state is switched to the imaging state (S2 state), the first target generation characteristic 21a is switched to the second target generation characteristic 21b.

Switching each of the target generation characteristic and the servo control characteristic in this way can maintain quietness in the imaging standby state (LV state). In the imaging preparation state (S1), the first target generation characteristic 21a is used and the user's framing operation is not hindered (low-frequency camera shake is not corrected). The second servo control characteristic 22b is used, camera shake (high-frequency camera shake) that is to be removed can be corrected even in the imaging preparation state, and a comfortable framing operation can be provided. In the imaging state (S2 state), the second target generation characteristic 21b is used, so low-frequency camera shake can be properly corrected. At the same time, because the servo control characteristic has already been switched to the second servo control characteristic 22b, changing the servo control characteristic does not cause minute movements of the image stabilizing unit 14 to negatively affect the captured image and result in a minute image blur.

At the imaging completion, first, the second target generation characteristic 21b is switched to the first target generation characteristic 21a when the imaging state (S2 state) is completed and the state changes to the imaging preparation state (LV state and S1 state). Thereafter, in a case where the imaging preparation state (LV state and S1 state) is released and switched to the imaging standby state (LV state and S1 released state), the imaging intent is no longer determined, and the second servo control characteristic 22b is switched to the first servo control characteristic 22a.

Switching each of the target generation characteristic and the servo control characteristic in this way can maintain the second servo control characteristic 22b even after imaging is completed, as long as the shutter release button is kept half-pressed (LV state and S1 state). Therefore, even when the imaging state (S2 state) is set again from the imaging preparation state (LV state and S1 state), imaging can be started without changing the servo control characteristic, so that imaging can be started without a release time lag. In a case where the imaging preparation state (LV state and S1 state) is released and switched to the imaging standby state (LV state and S1 released state), the second servo control characteristic 22b is switched to the first servo control characteristic 22a, so that quietness in the imaging standby state can be maintained again.

As with the conventional system, in a case where the second target generation characteristic 21b is changed to the first target generation characteristic 21a, the target generator is gradually switched to the first target generation characteristic 21a rather than all the way in one go. During this period, in a case where the imaging state (S2 state) is set again, the target generator is switched to the second target generation characteristic 21b again.

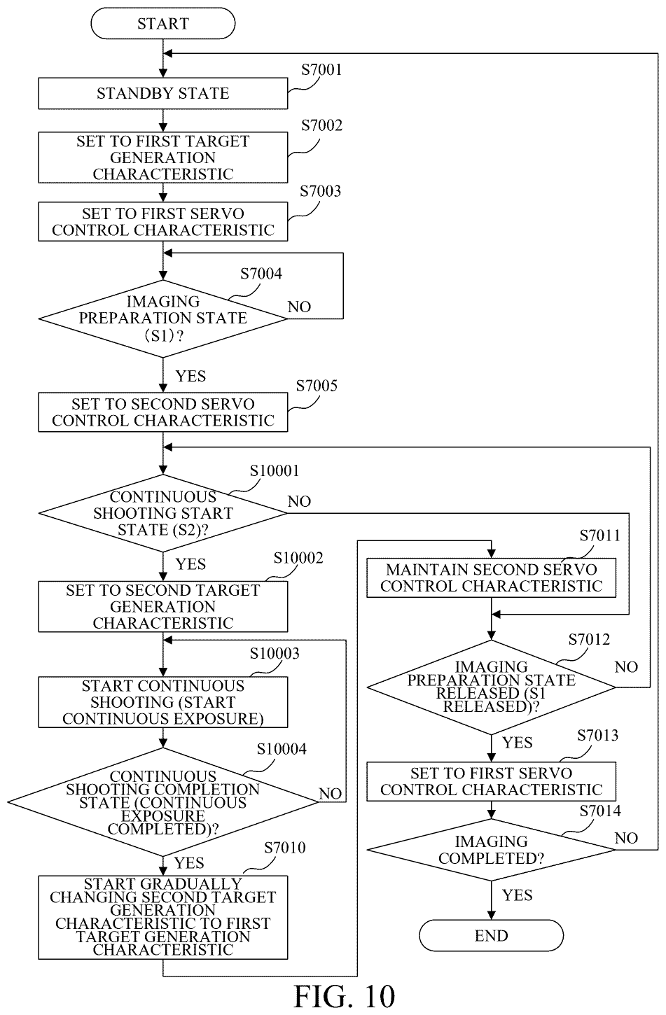

Referring now to FIG. 10, a description will be given of a control method for the imaging system 100 according to this embodiment. FIG. 10 is a flowchart illustrating the control method according to this embodiment. This flow starts when the camera body 1 is powered on. In FIG. 10, the basic control flow is similar to the control flow in the single-shot imaging mode illustrated in FIG. 7 of the first embodiment, and therefore the same step numbers (S7001 to S7005, S7010 to S7014) are used for the same control flow as in FIG. 7. Here, only the control flow different from FIG. 7 will be described, and a description common to FIG. 7 will be omitted.

In step S10001, the camera system control unit 5 determine whether or not a continuous shooting start instruction (so-called full pressing of the shutter release button, S2) has been input by the user (whether or not the camera is in a continuous shooting start state) using the imaging-start-state determining unit 18. In a case where it is determined that the camera is in the continuous shooting start state, the flow proceeds to step S10002. On the other hand, in a case where it is determined that the camera is not in the continuous shooting start state, the flow proceeds to step S7012.

In step S10002, the camera system control unit 5 sets the target generation characteristic of the target generator 21 to the second target generation characteristic 21b using the image stabilizing controller 16. Next, in step S10003, the camera system control unit 5 starts continuous shooting using the image sensor 6. Next, in step S10004, the camera system control unit 5 determines whether or not the continuous shooting state (S2 release state) has been released by the user (whether or not the continuous shooting has been completed) using the imaging-completion-state determining unit 19. In a case where it is determined that the continuous shooting state has been completed, the flow proceeds to step S7010. On the other hand, in a case where it is determined that the continuous shooting state has not yet been completed, the flow returns to step S10003, and the camera system control unit 5 continues the continuous shooting.

The flow thereafter proceeds in a manner similar to the flow illustrated in FIG. 7. In step S7010, the camera system control unit 5 gradually switches the target generation characteristic of the target generator 21 from the second target generation characteristic 21b to the first target generation characteristic 21a using the image stabilizing controller 16. Next, in step S7011, the camera system control unit 5 maintains the servo control characteristic of the servo control unit 22 at the second servo control characteristic 22b using the image stabilizing controller 16. Next, in step S7012, the camera system control unit 5 determines whether the imaging preparation state (S1 state) has been released, using the imaging-preparation-state determining unit 17. In a case where it is determined that the imaging preparation state has been released, the flow proceeds to step S7013. On the other hand, in a case where it is determined that the imaging preparation state has not been released, the flow returns to step S10001, and the camera system control unit 5 determines whether or not the continuous shooting start state (S2) is set using the imaging-start-state determining unit 18. Steps S7013 and after are similar to the control flow illustrated in FIG. 7.

As discussed above, even in continuous shooting mode, each of the target generation characteristic and servo control characteristic is changed according to the determination results of the imaging-preparation-state determining unit 17, imaging-start-state determining unit 18, and imaging-completion-state determining unit 19. Thus, an image with high image stabilizing performance can be captured just after imaging is started, while the driving noise of the image stabilizing unit can be maintained quiet during a period with no imaging intent.

Each embodiment can provide a control apparatus, an image pickup apparatus, a lens apparatus, a control apparatus, and a storage medium, each of which can reduce the driving noise of the image stabilizing unit without degrading image stabilizing performance.

### OTHER EMBODIMENTS

Embodiment(s) of the disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the disclosure has described example embodiments, it is to be understood that the disclosure is not limited to the example embodiments. The scope of the following claims is to be accorded the broadest interpretation so as to encompass all such modifications and equivalent structures and functions.

This application claims the benefit of Japanese Patent Application No. 2024-151856, which was filed on Sep. 4, 2024, and which is hereby incorporated by reference herein in its entirety.

What is claimed is:

1. A control apparatus comprising:
one or more memories storing instructions; and
one or more processors that, upon execution of the instructions, operate to:
calculate a correction amount for image stabilization using a signal obtained from a shake detector, and
control an image stabilizing unit configured to perform the image stabilization based on the correction amount and a control characteristic,
wherein the one or more processors have a first calculation characteristic, and a second calculation characteristic for calculating the correction amount that can correct a shake at a frequency lower than that of the first calculation characteristic, and the control characteristic includes a first control characteristic, and a second control characteristic having responsiveness higher than that of the first control characteristic, and
wherein in a case where a state is transitioned to a first state, a second state, and a third state in this order according to a user instruction, the one or more processors operate to:
switch the first calculation characteristic to the second calculation characteristic when the second state is transitioned to the third state, and
switch the first control characteristic to the second control characteristic when the first state is transitioned to the second state.

2. The control apparatus according to claim 1, wherein in a case where the state is transitioned to the first state, the second state, the third state, and a fourth state in this order according to the user instruction, the one or more processors operate to:
gradually switch the second calculation characteristic to the first calculation characteristic when the third state is transitioned to the fourth state, and
maintain the second control characteristic in the second state.

3. A control apparatus comprising:
one or more memories storing instructions; and
one or more processors that, upon execution of the instructions, operate to:
calculate a correction amount for image stabilization using a signal obtained from a shake detector, and
control an image stabilizing unit configured to perform the image stabilization based on the correction amount and a control characteristic,
wherein the one or more processors have a first calculation characteristic, and a second calculation characteristic for calculating the correction amount that can correct a shake at a frequency lower than that of the first calculation characteristic, and the control characteristic includes a first control characteristic, and a second control characteristic having responsiveness higher than that of the first control characteristic,
wherein in a case where a state is transitioned to a second state, a third state, and a fourth state in this order according to a user instruction, the one or more processors operate to:
gradually switch the second calculation characteristic to the first calculation characteristic when the third state is transitioned to the fourth state, and
maintain the second control characteristic in the second state.

4. The control apparatus according to claim 1, wherein the first control characteristic and the second control characteristic have different breakpoint frequencies of gain characteristics.

5. The control apparatus according to claim 4, wherein the second control characteristic has a breakpoint frequency higher than that of the first control characteristic.

6. The control apparatus according to claim 1, wherein the second control characteristic has less delay in a phase characteristic than that of the first control characteristic.

7. The control apparatus according to claim 1, wherein the first calculation characteristic has a gain cut in a low frequency band in comparison with the second calculation characteristic.

8. The control apparatus according to claim 1, wherein in a case where the first state is transitioned to the third state, the one or more processors operate to:
switch the first calculation characteristic to the second calculation characteristic, and
maintain the first control characteristic.

9. The control apparatus according to claim 1, wherein in a case where the first state is transitioned to the third state, the one or more processors operate to:
switch the first calculation characteristic to the second calculation characteristic, and
switch the first control characteristic to the second control characteristic.

10. The control apparatus according to claim 1, wherein in a case where the first state is transitioned to the third state, the one or more processors operate to:
switch the first calculation characteristic to the second calculation characteristic, and
change whether to maintain the first control characteristic or switch the first control characteristic to the second control characteristic, according to a user setting.

11. The control apparatus according to claim 1, wherein in a case where the first state is transitioned to the third state, the one or more processors operate to:
switch the first calculation characteristic to the second calculation characteristic, and
change whether to maintain the first control characteristic or switch the first control characteristic to the second control characteristic, according to a shutter speed.

12. The control apparatus according to claim 1, wherein the one or more processors operate to determine whether to switch the first control characteristic to the second control characteristic, using position information on the image stabilizing unit.

13. The control apparatus according to claim 1, wherein the second state is a state in which a light metering operation is being performed by a light metering unit.

14. The control apparatus according to claim 1, wherein the second state is a state in which a focus detector is performing focus detection.

15. An image pickup apparatus comprising:
the control apparatus according to claim 1; and
an image sensor.

16. The image pickup apparatus according to claim 15, wherein the second state is a state in which a shutter release button of the image pickup apparatus is half-pressed.

17. The image pickup apparatus according to claim 16, wherein the third state is a state in which imaging is started according to full pressing of the shutter release button.

18. The image pickup apparatus according to claim 17, wherein in a case where the state is transitioned to the second state, the third state, and a fourth state in this order according to the user instruction, the fourth state is a state in which imaging is completed according to full pressing of the shutter release button.

19. The image pickup apparatus according to claim 16, wherein in case where the state is transitioned to the first state, the second state, and the third state according to the user instruction, the first state is a state in which a live-view image is displayed on a display unit but the shutter release button is not half-pressed.

20. A lens apparatus comprising:
the control apparatus according to claim 1; and
an imaging optical system,
wherein the lens apparatus is attachable to and detachable from an image pickup apparatus.

21. The lens apparatus according to claim 20, wherein the second state is a state in which a shutter release button of the image pickup apparatus is half-pressed.

22. The lens apparatus according to claim 21, wherein the third state is a state in which imaging is started according to full pressing of the shutter release button.

23. The lens apparatus according to claim 22, wherein in a case where the state is transitioned to the second state, the third state, and a fourth state according to the user instruction, the fourth state is a state in which imaging is completed according to full pressing of the shutter release button.

24. The lens apparatus according to claim 23, wherein the first state is a state in which a live-view image is displayed on a display unit but the shutter release button is not half-pressed.

25. A control method comprising:
calculating a correction amount for image stabilization using a signal obtained from a shake detector; and
controlling an image stabilizing unit configured to perform the image stabilization based on the correction amount and a control characteristic,
wherein in calculating, a calculation characteristic for calculating the correction amount includes a first calculation characteristic, and a second calculation characteristic for calculating the correction amount that can correct a shake at a frequency lower than that of the first calculation characteristic, and the control characteristic includes a first control characteristic, and a second control characteristic having responsiveness higher than that of the first control characteristic,
wherein in a case where a state is transitioned to a first state, a second state, and a third state in this order according to a user instruction, the control method further comprises:
switching the first calculation characteristic to the second calculation characteristic when the second state is transitioned to the third state; and
switching the first control characteristic to the second control characteristic when the first state is transitioned to the second state.

26. A control method comprising:
calculating a correction amount for image stabilization using a signal obtained from a shake detector; and
controlling an image stabilizing unit configured to perform the image stabilization based on the correction amount and a control characteristic,
wherein in calculating, a calculation characteristic for calculating the correction amount includes a first calculation characteristic, and a second calculation characteristic for calculating the correction amount that can correct a shake at a frequency lower than that of the first calculation characteristic, and the control characteristic includes a first control characteristic, and a second control characteristic having responsiveness higher than that of the first control characteristic,
wherein in a case where a state is transitioned to a second state, a third state, and a fourth state in this order according to a user instruction, the control method comprises:
gradually switching the second calculation characteristic to the first calculation characteristic when the third state is transitioned to the fourth state; and
maintaining the second control characteristic in the second state.

27. A non-transitory computer-readable storage medium storing a program that causes a computer to execute the control method according to claim 25.

28. A non-transitory computer-readable storage medium storing a program that causes a computer to execute the control method according to claim 26.
